(19) United States
(12) Patent Application Publication
(10) Pub. No.: US 2006/0242220 A1
(43) Pub. Date: Oct. 26, 2006

(54) Hardware divider

(75) Inventors: Shereef Shehata, Allen, TX (US); Feng Ying, Plano, TX (US); Karl Hertzian Renner, Dallas, TX (US)

Correspondence Address: TEXAS INSTRUMENTS INCORPORATED, P O BOX 655474, M/S 3999, DALLAS, TX, 75265, US

(73) Assignee: Texas Instruments, Inc.

(21) Appl. No.: 11/110,032

(22) Filed: Apr. 20, 2005

(51) Int. Cl. G06F 7/52

(52) U.S. Cl. 708/650

(57) ABSTRACT

Systems and methods are provided for dividing two digital values. A look-up table provides a first output value in response to a value of an input signal. The first output value corresponds to a first estimate of a reciprocal for the value of the input signal. An approximation component provides a second output value corresponding to a second estimate of the reciprocal value for the value of the input signal as a function of the first output value and the value of the input signal. The look-up table is configured to provide the first output value within a predetermined error sufficient to enable the approximation component to improve the first estimate within a second predetermined error by the approximation component employing a single iteration of the function of the first output value and the value of the input signal.

### TECHNICAL FIELD

The present invention relates generally to electrical circuits, and more particularly systems and methods for determining the quotient of two digital values.

### BACKGROUND

Digital dividers generally can be categorized as employing arithmetic operations or look-up tables to execute a division operation. Lookup-type dividers receive an input that combines the numerator and denominator. They then output a quotient retrieved from a table, typically implemented in read-only memory (ROM). Look-up table implementations often require large look-up tables to be accurate for high-speed division, generally requiring significant processing time and chip space. Many look-up table implementations also require multiple iterations to improve accuracy, which iterations increase latency associated with the division operation.

One consideration in the design of digital dividers relates to the throughput of the division process that is required to obtain a quotient with a desired degree of accuracy. The throughput of the process determines the rate at which a new value can be initiated into the process, also referred to as the initiation interval. The throughput of the division process generally depends on the precision desired and the algorithm used. Another consideration is the processing time required to perform the digital division operation, which corresponds to the amount of time required to perform the division process, also referred to as latency. In many conventional digital divider designs, the latency determines the overall speed of the division process. As a result, most calculation-type dividers typically provide only a few bits of precision for real-time operation.

By way of example, one application of digital dividers is amplitude correction in demodulation systems. Audio and video decoding have traditionally been separated in television receivers. The RF signal received at the receiver is usually down-shifted into intermediate frequency (IF). An analog audio IF limiting amplifier may be used to output a constant amplitude audio IF signal. The audio IF signal can then be digitized and demodulated. The IF limiting can introduce harmonics into the audio IF, and usually the output of the audio IF limiting process is passed through a low pass filter to remove these harmonics before the audio IF signal is digitized.

This places tight design constraints on the passband of these analog components, so as not introduce notable amplitude variations in the FM modulated sound IF. Traditionally in television reception, audio FM demodulators used either a Foster-Sealy or ratio-detection method, which is done in the analog domain, or a phase locked loop (PLL) based method. In receivers using the Foster-Sealy approach, amplitude modulated noise making it through the IF stages will be present in the recovered audio. The PLL behaves as a narrow band tracking filter with its loop filter output exhibiting a frequency discriminating characteristics. However, the linearity of the VCO affects the overall linearity of the FM. Moreover, the PLL method can not adequately compensate for amplitude variations in the incoming audio IF signal. For instance, the PLL can generate significant noise when the lock threshold is modulated by amplitude modulated noise.

### SUMMARY

The present invention relates generally to a digital divider that can be pipelined to provide a high degree of precision. The digital divider includes a look-up table (e.g., read-only memory, field programmable gate array, or the like) that is configured according to a predefined precision of the divider. For instance, based on the predefined precision, error analysis can be employed to project the precision into the size of look-up table. Thus, a more optimal size look-up table can be implemented for the defined precision. The look-up table provides a first estimate to an approximation engine that provides a corresponding second estimate of the reciprocal value as a function of the first estimate and the value of the input signal. The digital divider affords pipelining with an initiation interval of one cycle, so that the approximation engine can provide a second estimate of the reciprocal value each cycle.

In accordance with an aspect of the present invention, a digital divider, implemented as an integrated circuit system, is provided. A look-up table provides a first output value in response to a value of an input signal. The first output value corresponds to a first estimate of a reciprocal for the value of the input signal. An approximation component provides a second output value corresponding to a second estimate of the reciprocal value for the value of the input signal as a function of the first output value and the value of the input signal. The look-up table is configured to provide the first output value within a predetermined error sufficient to enable the approximation component to improve the first estimate within a second predetermined error by the approximation component employing a single iteration of the function of the first output value and the value of the input signal.

In accordance with another aspect of the present invention, a method is provided for dividing a first value by a second value in real-time in a pipelined fashion. The second value is provided to a look-up table and an approximation of the reciprocal of the second value is retrieved from the look-up table. An approximation function, implemented in hardware, is applied non-iteratively to the retrieved approximation to produce a reciprocal value. The reciprocal value more accurately represents the reciprocal of the second value. The reciprocal value and the first value are multiplied to provide a value for a quotient of the first value and second value.

In accordance with another aspect of the present invention, a frequency modulated (FM) demodulation system with amplitude compensation is provided. A differentiator assembly determines at least one derivative associated with the FM signal. A combiner assembly determines a demodulated signal and an instantaneous amplitude of the demodulated signal from the FM signal and the associated at least one derivative of the FM signal. A pipeline divider includes a look-up table that provides a first output value in response to the instantaneous amplitude. The first output value corresponds to a first estimate of a reciprocal of the value of the instantaneous amplitude. The pipeline divider further includes an approximation component that provides a second output value corresponding to a second estimate of the reciprocal value for the value of the instantaneous amplitude as a function of the first output value and the value of the input signal. The look-up table is configured to provide the first output value within a predetermined error sufficient to enable the approximation component to improve the first estimate within a second predetermined error by the approximation component employing a single iteration of the function of the first output value and the value of the instantaneous amplitude.

### BRIEF DESCRIPTION OF THE DRAWINGS

The foregoing and other aspects of the present invention will become apparent to those skilled in the art to which the present invention relates upon reading the following description with reference to the accompanying drawings.

FIG. 1 illustrates a divider apparatus for calculating the quotient of two digital values in accordance with an aspect of the present invention.

FIG. 2 illustrates the format of an exemplary look-up table for a pipelined divider system in accordance with an aspect of the present invention.

FIG. 3 illustrates an apparatus for demodulating a frequency modulated signal utilizing a pipelined divider in accordance with an aspect of the present invention.

FIG. 4 illustrates a methodology for dividing two digital numbers in accordance with an aspect of the present invention.

### DETAILED DESCRIPTION

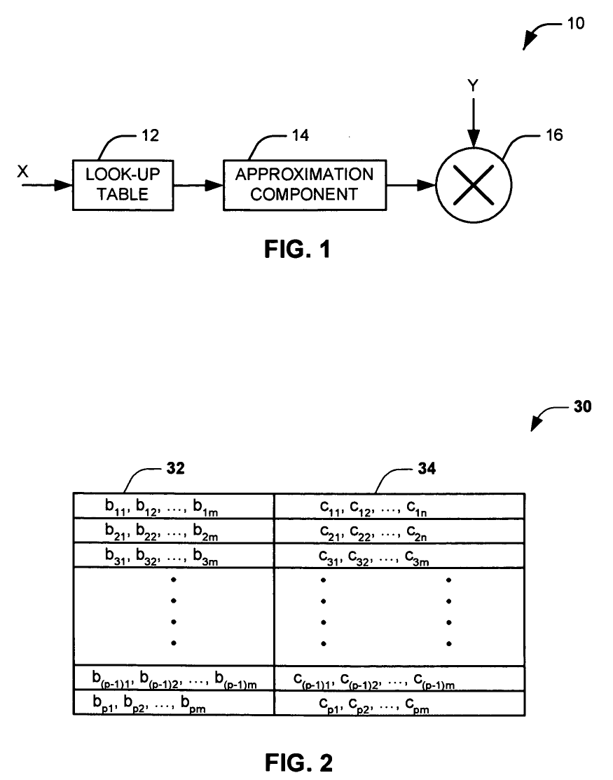

FIG. 1 illustrates a divider apparatus 10 for calculating the quotient of two digital values, a divisor, x, and a dividend, y (e.g., y/x). The apparatus 10 includes a look-up table 12 that provides a first estimate of the quotient in response to the input divisor x. For example, the look-up table can be implemented as read-only memory (ROM) or alternatively as an array of logic gates (e.g., a field programmable gate array FPGA)).

In a ROM implementation, the look-up table 12 includes a plurality of entries. Each entry comprises an input value, recorded as an m-bit word, and an output value, recorded as an n-bit word, where m and n are positive integers (m and n can be the same or different). Each output value represents the reciprocal of its associated input value to a defined degree of precision, such that the difference between the output value and the true value of the reciprocal remains below a first threshold error value for the entries in the look up table.

The size and configuration of the look-up table 12 can be predetermined based on the defined precision required for the division operation. For example, error analysis can be performed to compensate for potential variations in the input, x, according to the defined precision for the division operation. The results of the error analysis can be projected into the look-up table design so that a more optimal size look-up table can be implemented for achieving the defined precision. As an example, to achieve precision at or in excess of 24 bits, a 512 entry look-up table can be utilized in a pipelined divider that is implemented in accordance with an aspect of the present invention. This can be contrasted with conventional approaches that typically require 64 (or greater) Kbytes ROM to achieve just 16 bits of accuracy, and which further can not be pipelined, as described herein.

In response to an input divisor value, the look-up table 12 provides a corresponding output value, (1/x)ₐ to an approximation component 14. The approximation component 14 applies a non-iterative refinement function to the output value retrieved from the look-up table 12 to produce a second output value, 1/x. As used herein, “non-iterative” means that a single instance of a given function is applied to the output value (1/x)ₐ. “Non-iterative” does not require that the function be a normally non-iterative function, however. For instance, the function can be implemented as a single iteration of a predetermined algorithm, as described below.

The approximation component 14 provides the second output value to represent the reciprocal of the original input, x, with an accuracy that is greater than that of the original approximation (1/x)ₐ. For example, the refinement function and/or the accuracy (e.g., word size) of the look-up table approximation can be selected such that the second output value approximates the reciprocal of the original input within a second threshold error value. The second threshold error value can be determined according to a desired overall accuracy for the divider 10. The second output value can then be provided to a multiplier 16, which multiplies the second output value and the dividend, y, to obtain the desired quotient, y/x.

In accordance with an aspect of the present invention, the word size of the output values within the look up table can be determined according to the desired overall accuracy (e.g., number of bits of precision) of the division application. The impact of the refinement function on the accuracy of a given approximation can be determined via error analysis. As mentioned above, for example, the non-iterative function can be implemented as a single iteration of an iterative approximation method. In such a case, the impact of the non-iterative function can be determined from the known rate of convergence and any asymptotic error constant associated with the iterative method. Alternatively, the impact of a given function on the accuracy of the approximation can be determined empirically for a range of interest.

Once the impact of the refinement function is determined, a desired first threshold can be determined according to a desired accuracy of the second output and the known effect of the refinement function. For example, the Newton-Raphson approximation algorithm converges quadratically, such that a single iteration of the Newton-Raphson algorithm effectively squares the error of the input approximation. Thus, for a desired final error threshold, an initial error threshold can be determined according to the square root of the final threshold. The initial error threshold can then be used to set a minimum bit length for the output values listed in the look-up table. Accordingly, the size of the look-up table 12 can be minimized, allowing for pipelined operation of the divider.

With the approach described above, comprising the look-up table 12 that provides an initial estimate followed by a single iteration of accuracy improvement by the approximation component 14, the divider can employ pipelining with an initiation period of one clock cycle. Thus, for example, a new input value, x, can be accepted by the look-up table 12 of the divider each clock cycle, and the approximation component 14 can provide a new output each initiation interval (e.g., once per clock cycle).

FIG. 2 illustrates an example format of a look-up table (LUT) 30 that can be utilized to implement a pipelined divider system in accordance with an aspect of the present invention. For example, the LUT 30 can be implemented in read-only memory (ROM) indexed according to a range of inputs or a logic-implemented look-up table. Other approaches can also be employed for the LUT 30. The LUT 30 contains a plurality of index values 32 represented as m-bit words and corresponding n-bit output values 34. Each output value represents the reciprocal of a value represented by its associated index value to a degree of accuracy represented by its bit length. It will be appreciated that the size and speed of the LUT 30 is related to the size of its entries.

Since the signal amplitude will be limited to a known range of likely values, the size of the LUT can be reduced in range to limit the size of the LUT. Range reduction can be used to limit a range of input values for a function f(x) from an original range [a, b], to a more desirable range, [a′, b′]. An input value, x, is converted to corresponding value, y, that falls within the desired range. The function is evaluated at the new value, y. The result is then reconstructed from the result, f(y), to form the desired value, f(x).

For example, the input values can be represented as a set of normalized m-bit numbers. A range reduction for the LUT 30 can be achieved via a leading-one circuit that is composed of one logical XOR gate for each reduced bit. The LUT 30 provides n bits after the leading bit determined at the leading one circuit. The total size of the LUT 30 can thus be reduced without a loss of accuracy. Since the input and its reciprocal are both positive, the sign bit can be implied and is not required to be stored.

In the illustrated example, the reduced range operand is represented as 1, b₁, b₂, . . . , bₘ where the leading one is implied and does not index into the LUT 30. The output of the LUT 30 is represented as 0, c₁, c₂, . . . , cₙ, where all outputs can also have a leading one, which is not stored. The LUT 30 can be designed to compute a piecewise constant approximation of the reciprocal of the middle point between 1, c₁, c₂, . . . , cₘ and its successor point. The reciprocal of the middle point is rounded by adding 2⁻⁽ⁿ⁺²⁾ and then truncating the result to n+1 bits, producing 0, c₁, c₂, . . . , Cₙ.

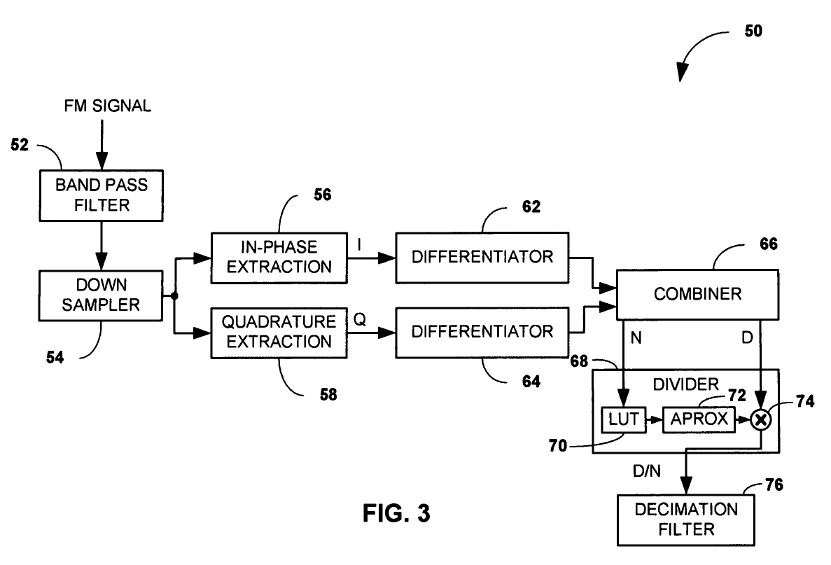

FIG. 3 illustrates an apparatus 50 for demodulating a frequency modulated (FM) signal utilizing a pipelined divider in accordance with an aspect of the present invention. The integrated digital FM demodulator apparatus 50 can accurately discriminate a small frequency deviation of the FM signal from its center frequency. As an example, the FM signal is an intermediate frequency (e.g., about 24.576 MHz) audio signal in BTSC (Broadcast Television System Committee) format, although the approach described herein is applicable to other signal formats. A band pass filter 52 removes any extraneous portions (e.g., luma and chroma signals) of the video signal from the BTSC composite signal. The band pass filter 52 can be selected and/or configured to have a frequency response that is as flat as possible in the pass band to avoid harmonic distortion. The output of the band pass filter 52 is then down sampled at a down sampler 54 to reduce the signal frequency to a more manageable speed for processing. For example, the down sampler 54 can down sample the signal by a factor of four.

The FM demodulation is achieved by differentiating the phase of the down sampled IF audio signal from the down sampler 54. The phase signal can be represented as the arc tangent of the quotient of the quadrature (Q) component and the in-phase (I) component. Respective extraction components 56 and 58 extract the in-phase and quadrature components of the down sampled signal. The in-phase and quadrature extraction components 56 and 58 can comprise suitable hardware components for extracting the relevant signal components.

For example, the extraction components 56 and 58 can each include a digitally tuned oscillator (DTO) comprising an accumulator register, whose contents are incremented by a value in an associated increment register. The accumulator value increments until it reaches an upper limit or a modulus that is determined by the number of bits in the accumulator register. The DTO output takes a sawtooth waveform approximating a sine function (for the in-phase extraction component 56) or a cosine function (for the quadrature extraction component 58). The sine and cosine functions for the respective in-phase and quadrature extraction components 56 and 58 further can be implemented by storing a fractional part (e.g., ⅛^{th}) of a cycle for that is shared between the sine and cosine functions. A given signal component can be extracted by multiplying the output of its respective DTO and the signal. The extracted signal components can be low pass filtered to remove higher frequency terms from the multiplication.

The in-phase and quadrature signal components are provided to respective differentiators 62 and 64. The differentiators 62 and 64 calculate an instantaneous numerical derivative of each of the signal components. In the illustrated example, the differentiation is performed at a high oversampling rate (e.g., one hundred and twenty-eight times the frequency of the audio signal).

These numerical derivatives and the signal values are provided to a combiner assembly 66. The FM demodulation is achieved by determining the derivative of the phase of the input signal. The phase signal can be represented as the arc tangent of the quadrature phase of the signal divided by the in-phase component. Accordingly, the combiner assembly 66 calculates a demodulated value for the signal (D) as the derivative of the arc tangent of the quadrature phase of the signal divided by the in-phase component from the provided signal components and their derivatives. The combiner assembly 66 also calculates a normalization value (N) representing the instantaneous amplitude of the signal.

The demodulated phase signal (D) and the normalization value (N) are provided to a divider 68, that is implemented in accordance with an aspect of the present invention. In the illustrated embodiment, the divider 68 includes a look-up table 70 implemented as a direct approximation look-up table. The direct approximation look-up table 70 receives the normalization value (N) and provides an approximate reciprocal (1/N), comprising an eight-bit word, of the value of the normalization value. This approximate reciprocal is then provided to an approximation component 72 that refines the initial approximation according to an associated non-iterative refinement function.

By way of further example, approximation component 72 can implement the non-iterative refinement function as one iteration of a Newton-Raphson approximation function using a priming function of f(x)=1/x−N=0. Accordingly, the non-iterative refinement function can be expressed as:

$${R}_{F} = {R}_{A} - \frac{f ( {R}_{A} )}{{f}^{′} ( {R}_{A} )} = {R}_{A} + \frac{( 1 / {R}_{A} - N )}{( 1 / {R}_{A}^{2} )} = {R}_{A} ( 2 - N * {R}_{A} )$$

where R_{F} is a final approximation of the reciprocal (1/N), R_{A} is an initial approximation of the reciprocal.

It will be appreciated that one iteration of the Newton-Raphson approximation can achieve a quadratic reduction in the error of an input approximation. Accordingly, a final value can be calculated within sixteen bit accuracy using an eight-bit input from the look-up table. The accuracy and speed of the calculation can be further improved via the use of range reduction, which limits the range of input and output values for the look-up table from their original ranges to more desirable range. A desired output can be reconstructed from the reduced range look-up table output. In an exemplary implementation, using a range reduced look-up table, twenty-four bit accuracy of the reciprocal can be achieved using an eight-bit look-up table output. Since the refinement function requires only a single iteration, it can be implemented in a pipelined fashion, allowing real-time calculation of the reciprocal.

A multiplier 74 multiplies the determined reciprocal, 1/N, by the demodulated signal value, D, to form a normalized signal, corresponding to the quotient D/N. The normalized signal is then provided to a series of one or more decimation filters 76. The decimation filters 76 can be configured to reduce the frequency of the signal by a desired factor. In one example, four stages of decimation filters can be used, with each filter providing decimating the signal by a factor of two. Each decimation stage can be preceded by a low pass decimation filter to prevent aliasing. The decimated signal is provided as the system output. Since the divider 68 can be pipelined, having an initiation interval of one clock cycle, the divider can achieve real time processing of the audio input signal.

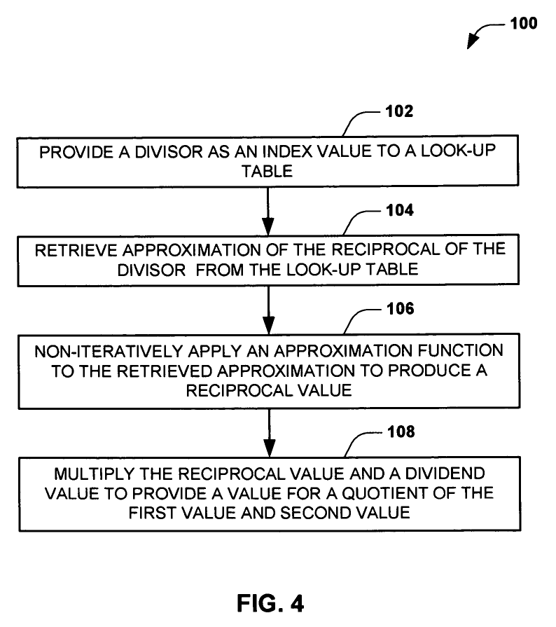

In view of the foregoing structural and functional features described above, a methodology in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates a methodology 100 for dividing two digital numbers, a first value representing a dividend and a second value representing a divisor, in a pipelined fashion. The methodology 100 begins at 102, where the second value is provided as an index value to a look-up table. At 104, an approximation of the reciprocal of the second value is provided by the look-up table. For example, the approximations within the look-up table can be selected to be within a first threshold error value, such as determined from error analysis. The error analysis, which can be performed offline, is employed to determine a precision required for the division process, based on which an optimal size of the look-up table can be determined.

At 106, an approximation function is non-iteratively applied to the retrieved approximation to produce a reciprocal value. This reciprocal value more accurately represents the reciprocal of the second value. For example, the first error threshold is selected such that the reciprocal value will be accurate within a second threshold error value, representing a desired output accuracy for the reciprocal, given an input accurate within the first error threshold. At 108, the reciprocal value and the first value are multiplied to provide a value for a quotient of the first value and second value. According to an aspect of the present invention, the method 100 can perform a new division operation every clock cycle. For example, by pipelining the look-up table function and the approximation function in hardware, the initiation interval for a new input into the look-up table can be every clock cycle and the approximation function can generate a corresponding quotient every clock cycle.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A digital divider system, implemented as an integrated circuit, comprising:
a look-up table that provides a first output value in response to a value of an input signal, the first output value corresponding to a first estimate of a reciprocal for the value of the input signal; and
an approximation component that provides a second output value corresponding to a second estimate of the reciprocal value for the value of the input signal as a function of the first output value and the value of the input signal, the look-up table being configured to provide the first output value within a predetermined error sufficient to enable the approximation component to improve the first estimate within a second predetermined error by the approximation component employing a single iteration of the function of the first output value and the value of the input signal.

2. The system of claim 1, the second predetermined error representing a desired degree of accuracy for a given application, and the first threshold being determined according to the second threshold and known accuracy of the output of the function associated with the approximation component for an input value having a given level of accuracy.

3. The system of claim 1, the approximation component applying one iteration of a Newton-Raphson algorithm to the first output value.

4. The system of claim 1, further comprising a multiplier that multiplies the second output value by a numerator input to obtain the quotient of the numerator input and the second output value.

5. The system of claim 1, the look-up table being implemented as a range reduced look-up table.

6. A frequency modulated (FM) demodulation system comprising the integrated circuit system of claim 1.

7. The FM demodulation system of claim 6, further comprising at least one extraction component that separates an input signal into in-phase and quadrature signal components.

8. The FM demodulation system of claim 7, each of the at least one extraction component comprising a digitally tuned oscillator that comprises an accumulator register and an increment register, the contents of the accumulator register being incremented by a value in the increment register.

9. The FM demodulated system of claim 7, further comprising a plurality of differentiators, each of the plurality of differentiators being operative to calculate a numerical derivative of an associated one of the in-phase and quadrature signal components, the in-phase and quadrature signal components being provided to the differentiators at an oversampled rate.

10. The FM demodulation system of claim 9, further comprising a combiner assembly that determines a demodulated signal and an amplitude of the demodulated signal from the in-phase and quadrature signal components and respective derivatives of the in-phase and quadrature signal components.

11. The FM demodulation system of claim 10, wherein the input signal of the digital divider is the instantaneous amplitude, and the second output value represents the reciprocal of the instantaneous amplitude, the FM demodulation system further comprising a multiplier that multiplies the second output value and the demodulated signal to produce a normalized signal.

12. A method for dividing a first value by a second value in a pipelined circuit, comprising:
providing the second value to a look-up table;
retrieving an approximation of the reciprocal of the second value from the look-up table;
non-iteratively applying an approximation function, implemented in hardware, to the retrieved approximation to produce a reciprocal value, the reciprocal value more accurately representing the reciprocal of the second value; and
multiplying the reciprocal value and the first value to provide a value for a quotient of the first value and second value.

13. The method of claim 12, a given approximation from the look-up table being selected as to be accurate within a first threshold error value, the first error threshold being selected such that the approximation function will produce a reciprocal value that is accurate within a second threshold error value, representing a desired output accuracy for the reciprocal value, given an approximation accurate within the first error threshold.

14. The method of claim 12, wherein the approximation function comprises one iteration of an iterative function.

15. A frequency modulated (FM) demodulation system with amplitude compensation comprising:
a differentiator assembly that determines at least one derivative associated with the FM signal;
a combiner assembly that determines a demodulated signal and an instantaneous amplitude of the demodulated signal based on the FM signal and the associated at least one derivative of the FM signal;
a pipeline divider comprising:
a look-up table that provides a first output value in response to the instantaneous amplitude, the first output value corresponding to a first estimate of a reciprocal of the value of the instantaneous amplitude;
an approximation component that provides a second output value corresponding to a second estimate of the reciprocal value for the value of the instantaneous amplitude as a function of the first output value and the value of the instantaneous amplitude, the look-up table being configured to provide the first output value within a predetermined error sufficient to enable the approximation component to improve the first estimate within a second predetermined error by the approximation component employing a single iteration of the function of the first output value and the value of the instantaneous amplitude; and
a multiplier that multiplies the second output value and the demodulated signal to produce a normalized signal corresponding to the quotient of the instantaneous amplitude and demodulated signal.

16. The system of claim 15, further comprising a phase splitter that divides the FM signal into in-phase and quadrature components, the differentiator determining the derivative of the in-phase and quadrature components of the FM signal.

17. The system of claim 15, further comprising a plurality of decimation filters that reduce the frequency of the normalized signal by a desired factor.

18. The system of claim 15, the look-up table being implemented as a range reduced look-up table.
